(19) United States
(12) Patent Application Publication
(10) Pub. No.: US 2012/0251343 A1
(43) Pub. Date: Oct. 4, 2012

(54) Control Valve and Variable Capacity Swash-Plate Type Compressor Provided with same

(75) Inventor: Yukihiko Taguchi, Gunma (JP)

(73) Assignee: Sanden Corporation, Gunma (JP)

(21) Appl. No.: 13/513,822

(22) PCT Filed: Dec. 3, 2010
(86) PCT No.: PCT/JP2010/007063

§ 371 Date: Jun. 4, 2012

(30) Foreign Application Priority Data
Dec. 4, 2009 (JP) 2009-277057

(51) Int. Cl. F04B 27/18; F04B 1/26; F16K 31/06

(52) U.S. Cl. 417/222.2; 251/129.15; 417/270

(57) ABSTRACT

[Object of the Invention] An object of the present invention is to provide a control valve that accommodates a pressure sensitive unit in a solenoid unit and is of simple structure.

[Disclosure of the Invention] A control valve for opening and closing a fluid passage comprises a pressure sensitive unit provided with a bellows for receiving outside fluid pressure to expand and retract, a valve body for opening and closing a fluid passage in response to the expansion and retraction of the bellows, and a solenoid unit for applying electromagnetic force to the valve body, wherein the pressure sensitive unit is disposed in the solenoid unit, the pressure sensitive unit comprises a movable end member made of ferromagnetic material at one end of the bellows and a fixed end member made of ferromagnetic material at the other end of the bellows, the movable end member and the fixed end member oppose each other with a predetermined distance disposed between them, and the movable end member and the fixed end member form a part of the magnetic circuit of the solenoid unit.

### TECHNICAL FIELD

The present invention relates to a control valve for opening and closing a fluid passage.

### BACKGROUND ART

Patent Documents No. 1 and No. 2 teach control valves for opening and closing a fluid passage each comprising a pressure sensitive unit provided with a bellows for receiving outside fluid pressure to expand and retract, a valve body for opening and closing a fluid passage in response to the expansion and retraction of the bellows, and a solenoid unit for applying electromagnetic force to the valve body, wherein the pressure sensitive unit is disposed in the solenoid unit. In the control valve of Patent Document No. 1, the pressure sensitive unit is disposed in the movable core of the solenoid unit. In the control valve of Patent Document No. 2, the pressure sensitive unit is disposed in the fixed core of the solenoid unit. The control valve is downsized by disposing the pressure sensitive unit in the solenoid unit.

### PRIOR ART DOCUMENTS

### Patent Documents

Patent Document No. 1: Japanese Patent Laid-Open Publication No. 2001-153256

Patent Document No. 2: Japanese Patent Laid-Open Publication No. 2006-118508

### DISCLOSURE OF INVENTION

### Problem to be Solved

Each of the control valves of Patent Documents No. 1 and No. 2 has a problem such that the control valve has a complicated structure and is difficult to assemble because the pressure sensitive unit disposed in the solenoid unit is independent of the solenoid unit.

An object of the present invention is to provide a control valve, wherein the pressure sensitive unit is disposed in the solenoid unit, and wherein the structure of the pressure sensitive unit is disposed in the solenoid unit, and wherein the structure of the control valve is simple. Another object of the present invention is to provide a variable capacity swash-plate type compressor comprising the aforementioned control valve.

### Means for Achieving the Object

In accordance with the present invention, there is provided a control valve for opening and closing a fluid passage comprising a pressure sensitive unit provided with a bellows for receiving outside fluid pressure to expand and retract, a valve body for opening and closing a fluid passage in response to the expansion and retraction of the bellows, and a solenoid unit for applying electromagnetic force to the valve body, wherein the pressure sensitive unit is disposed in the solenoid unit, the pressure sensitive unit comprises a movable end member made of ferromagnetic material at one end of the bellows and a fixed end member made of ferromagnetic material at the other end of the bellows, the movable end member and the fixed end member oppose each other in the bellows with a predetermined distance between them, and the movable end member and the fixed end member form a part of the magnetic circuit of the solenoid unit.

In the control valve in accordance with the present invention, a part of the magnetic circuit of the solenoid unit is formed in the pressure sensitive unit. Therefore, some of the structural members of the pressure sensitive unit can form some of the structural members of the solenoid unit so as to simplify the structure of the control valve, decrease the production cost of the control valve, and make the production of the control valve easy.

In accordance with a preferred embodiment of the present invention, the solenoid unit comprises a movable core and a fixed core. The movable end member of the pressure sensitive unit forms the movable core, and the fixed end member of the pressure sensitive unit forms the fixed core.

The movable end member of the pressure sensitive unit can form the movable core of the solenoid unit and the fixed end member of the pressure sensitive unit can form the fixed core of the solenoid unit.

In accordance with a preferred embodiment of the present invention, the control valve further comprises a biasing member for forcing the movable end member away from the fixed end member, and the biasing member is disposed in the internal space of the fixed end member.

When the biasing member is disposed in the internal space of the fixed end member, it becomes possible to increase the diameters of the movable end member and the fixed end member projecting into the internal space of the bellows up to a level substantially the same as the diameter of the bellows. Thus, sufficiently large magnetic pole area can be secured between the two end members.

In accordance with a preferred embodiment of the present invention, the control valve further comprises a transfer rod made of non-magnetic material and extending through the internal space of the fixed end member to abut the movable end member. The biasing member forces the movable end member away from the fixed end member through the transfer rod, and the transfer rod is provided with a minimum clearance restriction member for restricting the minimum clearance between the movable end member and the fixed end member to a predetermined level.

When the transfer rod made of non-magnetic material for transferring the biasing force of the biasing member to the movable end member is provided with a minimum clearance restriction member for restricting the minimum clearance between the movable end member and the fixed end member to a predetermined level, no other minimum clearance restriction member for restricting the minimum clearance between the movable end member and the fixed end member to a predetermined level is necessary. Thus, the structure of the control valve becomes simple.

In accordance with a preferred embodiment of the present invention, the control valve further comprises a sleeve of cylindrical form closed at one end for accommodating the pressure sensitive unit in its center portion. The outer circumferential surface of the fixed end member is press fitted in and fixed to the inner circumferential surface of the sleeve, and the outer circumferential surface of the movable end member is slidably supported by the inner circumferential surface of the sleeve.

The pressure sensitive unit can be easily supported by and fixed to the sleeve. Deflection of the movable end member in the radial direction also can be restricted by the sleeve.

In accordance with the present invention, the movable end member is provided with a communication passage between the fluid passage and the space around the bellows on the outer circumferential surface.

The aforementioned communication passage can reliably apply the fluid pressure to the space around the bellows so as to reliably expand and contract the bellows in response to fluctuation of the fluid pressure.

In accordance with a preferred embodiment of the present invention, the internal pressure of the pressure sensitive unit is kept negative.

When the internal pressure of the pressure sensitive unit is kept negative, no foreign matter entrained by the fluid enters into the space between the movable end member and the fixed end member. Thus, the operation of the bellows is not obstructed by the foreign matters.

In accordance with a preferred embodiment of the present invention, the bellows is made of stainless steel.

When connectability between the bellows and the movable end member or the fixed end member, which are made of soft iron, electromagnetic stainless steel, etc., is taken into consideration, the bellows is desirably made of stainless steel.

In accordance with a preferred embodiment of the present invention, the fluid is refrigerant flowing in a variable capacity swash-plate type compressor, the fluid passage is a communication passage between an outlet chamber and a crank chamber of the compressor and/or a communication passage between the crank chamber and an inlet chamber of the compressor, and the fluid pressure is the internal pressure of the crank chamber or the internal pressure of the inlet chamber.

The fluid passage to be opened and closed by the control valve can be a communication passage between an outlet chamber and a crank chamber of the compressor and/or a communication passage between the crank chamber and an inlet chamber of the compressor. The fluid pressure applied to the pressure sensitive unit can be the internal pressure of the crank chamber or the internal pressure of the inlet chamber.

In accordance with the present invention, there is provided a variable capacity swash-plate type compressor comprising the aforementioned control valve.

Variable capacity swash-plate type compressors control the internal pressure of the crank chambers by using control valves each comprising a pressure sensitive unit for detecting refrigerant pressure and a solenoid unit for variably controlling the operating point of the pressure sensitive unit. When the control valve in accordance with the present invention is used for a variable capacity swash-plate type compressor, the structure of the compressor becomes simple and production cost of the compressor decreases.

In accordance with a preferred embodiment of the present invention, the compressor comprises a housing accommodating an outlet chamber, an inlet chamber, a crank chamber and a plurality of cylinder bores, a plurality of pistons each fitting in one of the cylinder bores, a driving shaft extending across the crank chamber, a conversion device provided with a swash plate variable in inclination to convert rotation of the driving shaft to reciprocation of the pistons, a first communication passage for communicating the outlet chamber to the crank chamber, the control valve for opening and closing the first communication passage, a second communication passage for communicating the crank chamber to the inlet chamber, and an aperture disposed in the second communication passage. The aperture of the control valve is controlled to control the internal pressure of the crank chamber, thereby controlling the stroke of the pistons to control flow rate of the refrigerant sucked into the cylinder bores from the inlet chamber. The control valve forms an autonomous control valve mechanism for autonomously controlling the internal pressure of the inlet chamber at a predetermined level when the pressure sensitive unit is connected to the valve body, wherein the valve body moves in the direction for closing the first communication passage when the internal pressure of the inlet chamber becomes higher than said level determined by the electromagnetic force of the solenoid, and the valve body moves in the direction for opening the first communication passage when the internal pressure of the inlet chamber becomes lower than said level. The connection between the pressure sensitive unit and the valve body forms a valve mechanism for forming a third communication passage extending through the valve body so as to communicate the crank chamber with the inlet chamber when the pressure sensitive unit and the valve body are disconnected from each other. The movable end member of the pressure sensitive unit is provided with a connection member for connecting it to the valve body, the connection member is fixed to the movable end member, and the connection between the pressure sensitive unit and the valve body is made of non-magnetic material.

The connection between the pressure sensitive unit and the valve body forms a valve mechanism. The connection between the pressure sensitive unit and the valve body is made of non-magnetic material. Therefore, no magnetic foreign matter adheres to the contact region of the connection between the pressure sensitive unit and the valve body so as to obstruct connecting and disconnecting operation of the connection between the pressure sensitive unit and the valve body.

### BRIEF DESCRIPTION OF THE DRAWINGS

FIG. 1 is a side sectional view of a variable capacity swash-plate type compressor provided with a control valve in accordance with a first preferred embodiment of the present invention.

FIG. 2 is a set of sectional views of the control valve in accordance with the first preferred embodiment of the present invention. (a) is a general sectional view, (b) is a view showing a first communication passage, (c) is a view showing a third communication passage, (d) is a view showing a pressure sensitive unit, and (e) is a view showing a sleeve.

FIG. 3 is a view showing a control characteristic of inlet pressure of the control valve in accordance with the first preferred embodiment of the present invention.

FIG. 4 is a set of sectional views of a control valve in accordance with the second preferred embodiment of the present invention. (a) is a general sectional view, (b) is a view showing a communication passage.

FIG. 5 is a sectional view of a control valve in accordance with another preferred embodiment of the present invention.

FIG. 6 is a sectional view of a control valve in accordance with another preferred embodiment of the present invention.

FIG. 7 is a sectional view of a control valve in accordance with another preferred embodiment of the present invention.

### MODES FOR CARRYING OUT THE INVENTION

Preferred embodiments of the present invention will be described.

### Preferred Embodiment 1

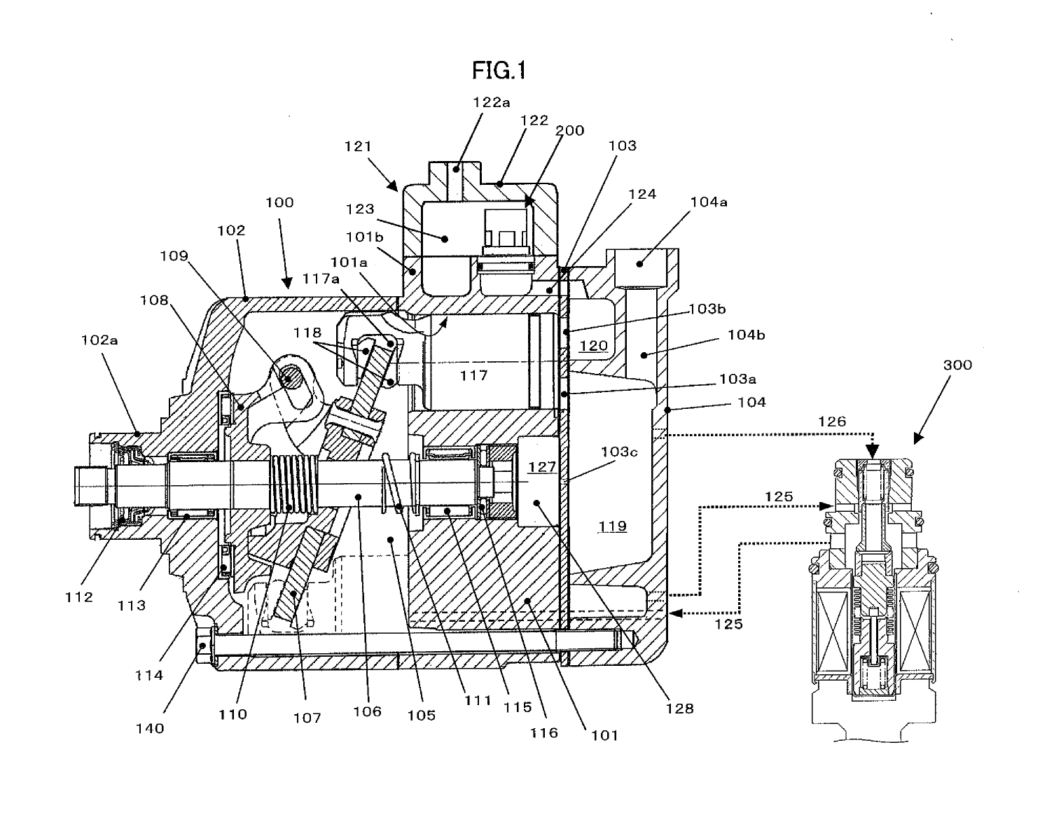

As shown in FIG. 1, a variable capacity swash-plate type compressor 100 comprises a cylinder block 101 provided with a plurality of cylinder bores 101a, a front housing 102 opposing one end of the cylinder block 101, and a cylinder head 104 opposing the other end of the cylinder block 101 with a valve plate 103 inserted between them.

The cylinder block 101 cooperates with the front housing 102 to define a crank chamber 105. A driving shaft 106 extends across the crank chamber 105. The driving shaft 106 passes through a swash plate 107 at the longitudinal middle. The swash plate 107 is connected to a rotor 108 fixed to the driving shaft 106 through a link 109. The driving shaft 106 supports the swash plate 107 variably at an inclination. A coil spring 110 is disposed between the rotor 108 and the swash plate 107 to force the swash plate 107 in a direction for decreasing the inclination to minimum level. A coil spring 111 is also provided. The coil spring 111 and the coil spring 110 are disposed to face opposite surfaces of the swash plate 107. The coil spring 111 forces the swash plate 107 in the direction for increasing the inclination.

The driving shaft 106 extends through and out of a boss 102a projecting outward from the front housing 102 to be connected to a transmission not shown in FIG. 1. A shaft seal 112 is disposed between the driving shaft 106 and the boss 102a to shut the crank chamber 105 off from the environment. The driving shaft 106 is supported radially and longitudinally by bearings 113, 114, 115 and 116. The driving shaft 106 rotates synchronously with the rotation of the transmission to which driving power is transmitted from an external power source.

Pistons 117 are inserted into the cylinder bores 101a. Each piston 117 is provided with a concave 117a at one end. The concave 117a accommodates the outer periphery of the swash plate 107. The piston 117 interlocks with the swash plate 107 through a pair of shoes 118. Thus, rotation of the driving shaft 106 is converted to reciprocal movement of the piston 117 in the cylinder bore 101a.

The cylinder head 104 forms an inlet chamber 119 and an outlet chamber 120. The inlet chamber 119 communicates with the cylinder bores 101a through communication holes 103a formed in the valve plate 103 and suction valves. The outlet chamber 120 communicates with the cylinder bores 101a through discharge valves and communication holes 103b formed in the valve plate 103. The suction valves and the discharge valves are not shown in FIG. 1.

The front housing 102, a center gasket, the cylinder block 101, a cylinder gasket, an inlet valve forming member, the valve plate 103, an outlet valve forming member, a head gasket, and the cylinder head 104 are connected to each other by a plurality of through bolts 140 to form a compressor housing. The center gasket, the cylinder gasket, the inlet valve forming member, the outlet valve forming member, and the head gasket are not shown in FIG. 1.

A muffler 121 is provided in the cylinder block 101. The muffler 121 is constituted by a cover 122 and a cylindrical wall 101b formed on the outer circumferential surface of the cylinder block 101 connected to each other with a seal member inserted between them so as to form a muffler space 123. A check valve 200 is disposed in the muffler space 123. The check valve 200 is located at the connection between an outlet passage 124 and the muffler space 123 to operate in response to pressure difference between the internal pressure of the upstream side outlet passage 124 and the internal pressure of the downstream side muffler space 123, thereby closing the outlet passage 124 when the pressure difference is smaller than a predetermined level, and opening the outlet passage 124 when the pressure difference is larger than the predetermined level. Therefore, the outlet chamber 120 communicates with a high pressure side refrigerant circuit of an air conditioner through the outlet passage 124, the check valve 200, the muffler space 123 and an outlet port 122a.

An inlet port 104a is provided in the cylinder head 104 to connect to a lower pressure side refrigerant circuit of the air conditioner. The inlet port 104a connects to the inlet chamber 119 through an inlet passage 104b.

A control valve 300 is fitted to the cylinder head 104. The control valve 300 controls the aperture of a first communication passage 125 extending between the outlet chamber 120 and the crank chamber 105 to control the flow rate of discharge refrigerant gas passing into the crank chamber 105. The refrigerant gas in the crank chamber 105 is passed into the inlet chamber 119 through a second communication passage 128 formed by spaces between the bearings 115, 116 and the driving shaft 106, a space 127 formed in the cylinder block 101 and a fixed orifice hole 103c formed in the valve plate 103. The control valve 300 can variably control the flow rate of discharge refrigerant gas passing into the crank chamber 105 to variably control the internal pressure of the crank chamber 105, thereby variably controlling the inclination angle of the swash plate 107, i.e., the stroke of the pistons 117 to variably control the capacity of the variable capacity swash-plate type compressor 100. The control valve 300 is an externally controlled valve. The operation of the control valve 300 is based on control of electric current supply to a solenoid unit of the control valve 300 and detection of the internal pressure of the inlet chamber 119 through a communication passage 126. The control valve 300 controls the capacity of the compressor 100 so as to keep the internal pressure of the inlet chamber 119 at a predetermined level.

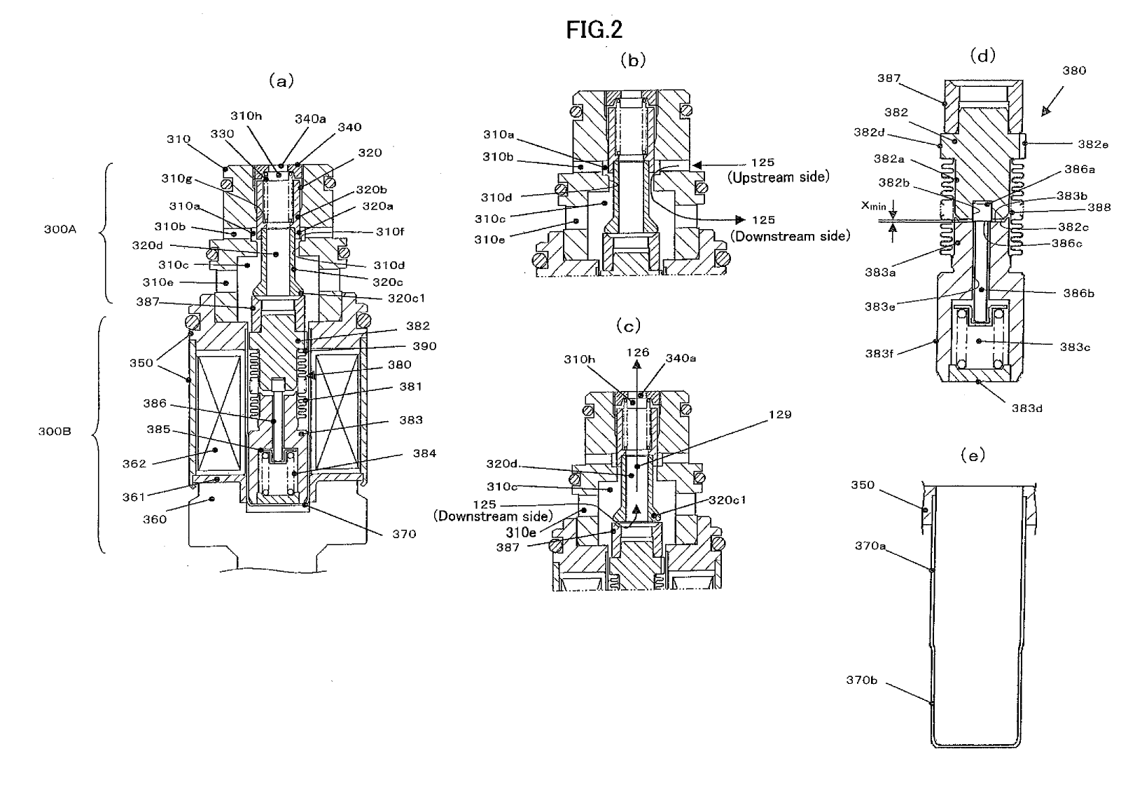

As shown in FIG. 2, the capacity control valve 300 comprises a valve unit 300A and a solenoid unit 300B.

The valve unit 300A comprises a valve housing 310, a valve body 320, a spring 330 for forcing the valve body 320 in the direction of closing and an adjusting member 340 for adjusting the biasing force of the spring 330.

A chamber 310a is formed in the valve housing 310 to accommodate a valve portion 320a of the valve body 320. The chamber 310a communicates with the outlet chamber 120 through a communication hole 310b and the upstream portion of the first communication passage 125. A chamber 310c is formed adjacent to the chamber 310a. The chamber 310c communicates with the chamber 310a through a valve hole 310d and also with the crank chamber 105 through a communication hole 310e and the downstream portion of the first communication passage 125. Thus, the communication hole 310b, the chamber 310a, the valve hole 310d, the chamber 310c and the communication hole 310e cooperate to form a part of the first communication passage 125. A valve seat 310f formed by a conical slope is disposed around the valve hole 310d.

The valve body 320 is constituted by the valve portion 320a, a shaft portion 320b and a connection member 320c. The valve body 320 is made of non-magnetic material. The valve portion 320a and the shaft portion 320b cooperate to form a cylinder provided with uniform outer diameter distribution in the longitudinal direction. The outer circumferential surface of the shaft portion 320b is slidably supported by a supporting hole 310g formed in the valve housing 310, and the outer peripheral portion of the end face of the valve portion 320a is contacted with and detached from the valve seat 310f to open and close the valve hole 310d. The connection member 320c is fitted in and fixed to the valve portion 320a at the base portion to extend toward the chamber 310c, thereby detachably connecting to a pressure sensitive unit 380 at the tip portion 320c1. The pressure sensitive unit 380 will be described in detail later.

The other end portion of the valve body 320, i.e., the shaft portion 320b, is accommodated in a chamber 310h. The chamber 310h communicates with the inlet chamber 119 through a communication hole 340a formed in an adjusting member 340 and the communication passage 126. A communication hole 320d is formed in the valve body 320. The communication hole 320d can communicate the chamber 310h with the chamber 310c as described in detail later. When the chamber 310h communicates with the chamber 310c through the communication hole 320d, the downstream portion of the first communication passage 125, the communication hole 310e, the chamber 310c, the communication hole 320d, the chamber 310h, the communication hole 340a and the communication passage 126 cooperate to form a third communication passage 129 for bypassing the second communication passage 128 to communicate the crank chamber 105 with the inlet chamber 119.

The solenoid unit 300B comprises a solenoid housing 350, a mold coil 360 accommodated in the solenoid housing 350, a sleeve 370 of cylindrical form closed at one end fixed to the solenoid housing 350 to be disposed in the center of the mold coil 360, and a pressure sensitive unit 380 accommodated in the sleeve 370.

The pressure sensitive unit 380 comprises a bellows 381, an end member 382 for closing one end of the bellows 381, an end member 383 for closing the other end of the bellows 381, a spring 384 for forcing the end member 382 away from the end member 383, a spring guide 385, a rod 386 for transmitting the biasing force of the spring 384 to the end member 382, and a connection member 387 fixed to the end member 382. The end member 382 forms a movable end member of the pressure sensitive unit 380 and the end member 383 forms a fixed end member of the pressure sensitive unit 380.

The end members 382 and 383 are made of ferromagnetic material. Projecting portions 382a and 383a of the end members 382 and 383 project into the internal space of the bellows 381 to oppose each other at a predetermined distance from each other. Therefore, the end member 382 operates as a movable core of the solenoid unit 300B and the end member 383 operates as a fixed core of the solenoid unit 300B. Soft iron, electromagnetic stainless steel, or the like, is used as the ferromagnetic material.

The bellows 381 is made of phosphor bronze, stainless steel, etc. The bellows 381 is made of a material other than that of the end members 382 and 383. An optimum connecting method should be used for connecting the bellows 381 with the end members 382 and 383. Examples of the optimum method are welding, blazing, soldering, adhesion, etc. Considering the connectability between the bellows 381 and the end members 382 and 383 made of soft iron, electromagnetic stainless, etc., the bellows 381 is desirably made of stainless steel. The internal space of the bellows 381 is kept at negative pressure.

The rod 386 comprises a large diameter portion 386a and a small diameter portion 386b. The large diameter portion 386a is accommodated in an accommodation hole 382b formed in the end member 382, and the small diameter portion 386b is forced by the spring 384 through the spring guide 385 at one end. The end face 386c of the large diameter portion 386a slightly projects from the end face 382c of the end member 382. Therefore, the end face 386c of the large diameter portion 386a abuts the end face 383b of the end member 383 when the bellows 381 contracts, and a minimum clearance x min. is formed between the end member 382 and the end member 383. Therefore, the large diameter portion 386a forms a minimum clearance restriction member for restricting the minimum clearance between the end member 382 and the end member 383 to x min. The rod 386 is made of non-magnetic material. Therefore, the rod 386 is not attracted by the end members 383 and 382 and does not disturb the expansion and contraction movement of the bellows 381.

The spring 384 and the spring guide 385 are accommodated in a chamber 383c formed in the end member 383, and the chamber 383c is closed by a cover 383d. The chamber 383c communicates with the internal space 388 of the bellows 381 through a hole 383e to be passed through by the rod 386. The internal space of the pressure sensitive unit 380 is shut off from the environment and kept under vacuum.

Outer diameters of the projecting portions 382a and 383a are set at the maximum level allowing the projecting portions 382a and 383a to be accommodated in the bellows 381 so as to maximize the magnetic pole area of the end faces 382c and 383b.

The sleeve 370 comprises a large diameter portion 370a and a small diameter portion 370b. The open end of the sleeve 370 connects to the chamber 310c. The pressure sensitive unit 380 is press fitted in and fixed to the inner circumferential surface of the small diameter portion 370b at the outer circumferential surface 383f of the end member 383 to be held by the sleeve 370. The length of the press fitting of the end member 383 into the small diameter portion 370b is adjusted to a level that enables a predetermined clearance to be formed between the end face 382c and the end face 383b, more concretely, that enables a clearance between the movable core and the fixed core of the solenoid unit 300B to be secured and expansion and contraction of the bellows 381 to be allowed when the connection member 387 of the pressure sensitive unit 380 abuts the connection member 320c of the valve body 320.

The end member 382 is slidably supported by the inner circumferential surface of the large diameter portion 370a of the sleeve 370 at the outer circumferential surface 382d. The large diameter portion 370a is desirably made of non-magnetic material so as to allow sliding contact of the outer circumferential surface 382d of the end member 382 made of ferromagnetic material. The small diameter portion 370b is desirably made of ferromagnetic material as the end member 383 is press fitted in and fixed to the small diameter portion 370b. The end member 382 is provided with at least one groove 382e for communicating the chamber 310c with a space 390 formed in the sleeve 370 and around the bellows 381. Therefore, refrigerant pressure in the chamber 310c, i.e., internal pressure of the crank chamber, is reliably applied to the space around the bellows 381. A plurality of grooves 382e can be provided.

The solenoid housing 350 and a plate 361 contacting the solenoid housing 350 and also embedded in the mold coil 360 are made of ferromagnetic material. When an electric current flows through a coil 362, a magnetic circuit is formed by the solenoid housing 350, the plate 361, the small diameter portion 370b of the sleeve 370, the end member 383, and the end member 382 to generate a biasing force for attracting the end member 382 toward the end member 383. Thus, electromagnetic force generated by the solenoid unit 300B and biasing force due to the refrigerant gas pressure contract the bellows 381, and the biasing force of the spring 384 expands the bellows 381. Therefore, the movable end member of the pressure sensitive unit 380, i.e., the end member 382, moves in the direction of expansion and contraction of the bellows 381 in response to the balance among the electromagnetic force of the solenoid unit 300B, the biasing force due to the refrigerant gas pressure and the biasing force of the spring 384 and the bellows 381 itself.

One end of the valve housing 310 of the valve unit 300A is press fitted in and fixed to one end of the solenoid housing 350 of the solenoid unit 300B to constitute the control valve 300.

Operation of the control valve 300 will be described.

When the valve body 320 connects to the pressure sensitive unit 380, the valve body 320 moves in response to the expansion and contraction of the bellows 381 to control the aperture of the first communication passage 125, thereby controlling the flow rate of the refrigerant gas passing into the crank chamber 105 from the outlet chamber 120. The connection member 387 of the pressure sensitive unit 380 comes into contact with and comes out of contact with the tip 320c1 of the connection member 320c of the valve body 320.

The contact region between the connection member 387 and the tip portion 320c1 of the connection member 320c forms a valve device. Therefore, the third communication passage 129 is closed when connection member 387 comes into contact with the tip portion 320c1 of the connection member 320c, and the third communication passage 129 is opened when connection member 387 comes out of contact with the tip portion 320c1 of the connection member 320c.

The third communication passage 129 is closed when the valve body 320 is connected to the pressure sensitive unit 380, that is the first communication passage 125 is opened, so as to place the crank chamber 105 into communication with the inlet chamber 119 only through the second communication passage 128. The second communication passage 128 is provided with the fixed orifice hole 103c. Therefore, the internal pressure of the crank chamber 105 is controlled by controlling the aperture of the first communication passage 125 by the valve body 320 to variably control the inclination of the swash plate 107, thereby variably controlling the capacity of the compressor 100.

When the bellows 381 contracts and the connection member 387 comes out of contact with the tip portion 320c1 of the connection member 320c, the valve body 320 is forced by the spring 330 to contact the valve seat 310f, thereby closing the first communication passage 125 to stop the flow of the refrigerant gas from the outlet chamber 120 to the crank chamber 105. On the other hand, the crank chamber 105 communicates with the inlet chamber 119 through the second communication passage 128 and the third communication passage 129. As a result, the internal pressure of the crank chamber 105 becomes equal to the internal pressure of the inlet chamber 119 to maximize the inclination of the swash plate 107, thereby maximizing the capacity of the compressor 100.

Internal pressure Ps of the inlet chamber 119 is applied to the valve body 320 from the side of the chamber 310h in the closing direction, and internal pressure Pc of the crank chamber 105 is applied to the valve body 320 from the side of the valve hole 310d in the opening direction. Resultant force F1 of the refrigerant gas pressure and the biasing force of the spring 330 applied to the valve body 320 is indicated by the following formula (1). In the formula (1), Sr means the area for receiving the internal pressure of the inlet chamber 119, Sv means the area for receiving the internal pressure of the crank chamber 105, Pd means the internal pressure of the outlet chamber 120, and fs means the biasing force of the spring 330.

F1=fs+Ps·Sr+(Sr−Sv)·Pd−Pc·Sv (1)

Now, Sv and Sr are designed to be Sv=Sr.

Therefore, the formula (1) is rewritten as follows.

F1=fs+Ps·Sr−Pc·Sv (1′)

As understood from formula (1′), the internal pressure Pd of the outlet chamber 120 is not applied to the valve body 320 in the opening or closing direction.

Biasing force F2 generated by the solenoid unit 300B is indicated by the following formula (2). In the formula (2), f(I) means electromagnetic force generated by the solenoid unit 300B, Sb means effective pressure receiving area of the bellows 381, and Fb means the biasing force of the bellows 381, i.e., sum of the biasing force of the spring 384 and the biasing force of the bellows itself.

F2=f(I)+Pc·Sb−Fb (2)

Therefore, the formula of operation characteristic of the control valve 300 is indicated by the following formula (3) on the ground that F1+F2=0.

fs+Ps·Sr−Pc·Sv+f(I)+Pc·Sb−Fb=0 (3)

Now, Sb and Sv are designed to be Sb=Sv.

Therefore, the formula (3) is rewritten as follows.

fs+Ps·Sr+f(I)−Fb=0

That is,

Ps=−(f(I)/Sr)+(Fb−fs)/Sr (4)

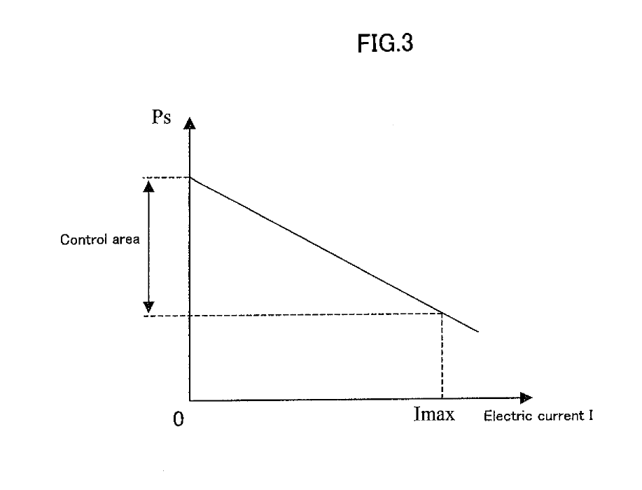

From formula (4), it can be seen that the control valve 300 detects the internal pressure of the inlet chamber 119 to control the opening and closing operation of the valve body 320, thereby controlling the capacity of the compressor 100 to keep the internal pressure of the inlet chamber 119 at a level determined by the electromagnetic force of the solenoid unit 300B. As shown in FIG. 3, the control valve 300 is provided with a control characteristic such that the internal pressure of the inlet chamber decreases as the electric power supply to the coil 362 increases.

When the pressure sensitive unit 380 and the valve body 320 connect to each other, the control valve 300 constitutes a valve device for autonomously controlling the internal pressure of the inlet chamber at a predetermined level, wherein the bellows 381 contracts to move the valve body 320 in the direction for closing the first communication passage 125 between the outlet chamber 120 and the crank chamber 105 when the internal pressure of the inlet chamber 119 increases beyond the level predetermined by the electromagnetic force of the solenoid unit 300B, and the bellows 381 expands to move the valve body 320 in the direction for opening the first communication passage 125 between the outlet chamber 120 and the crank chamber 105 when the internal pressure of the inlet chamber 119 decreases beyond the level predetermined by the electromagnetic force of the solenoid unit 300B. The predetermined level of the internal pressure of the inlet chamber 119 can be fine controlled by adjusting the biasing force fs of the spring 330 with an adjusting member 340.

When the internal pressure of the inlet chamber 119 is higher than the level predetermined by the electromagnetic force of the solenoid unit 300B, the bellows 381 contracts to make the valve portion 320a of the valve body 320 abut the valve seat 310f, thereby closing the first communication passage 125, and the connection member 387 detaches from the connection member 320c to open the third communication passage 129. Thus, the crank chamber 105 communicates with the inlet chamber 119 through the second communication passage 128 and the third communication passage 129.

When a large quantity of refrigerant liquid remains in the crank chamber 105 of the variable capacity compressor 100 provided with a conventional control valve at the time of startup of the air conditioner, the capacity of the compressor is maintained substantially minimum level until the refrigerant liquid in the crank chamber 105 is fully discharged to the inlet chamber 119a, which inhibits rapid cooling. When the control valve 300 is used instead of the conventional control valve, the crank chamber 105 communicates with the inlet chamber 119 through the second communication passage 128 and the third communication passage 129 to achieve rapid discharge of the refrigerant liquid in the crank chamber 105 to the inlet chamber 119, thereby achieving rapid increase of the capacity of the compressor and rapid approach of the internal pressure of the inlet chamber 119 to the predetermined level. The electromagnetic force of the solenoid unit 300B is directly applied to the movable end member of the pressure sensitive unit 380, i.e., the end member 382. Therefore, the third communication passage 129 is kept open until the internal pressure of the inlet chamber 119 becomes the level predetermined by the electromagnetic force of the solenoid unit 300B. As a result, the following effect is obtained, namely that the crank chamber 105 communicates with the inlet chamber 119 through the second communication passage 128 and the third communication passage 129 when the compressor operates at the maximum capacity to rapidly discharge the refrigerant in the crank chamber 105 to the inlet chamber 119. The connection members 387 and 320c are made of non-magnetic material. Therefore, the contact region between the connection member 387 and the connection member 320c does not attract ferrous foreign matters even if the end member 382 is magnetized. Therefore, the opening and closing operation of the contact region between the connection member 387 and the connection member 320c, which forms a valve device, is not obstructed.

In the control valve 300, a part of the magnetic circuit of the solenoid unit 300B is formed in the pressure sensitive unit 380. Therefore, the structural members 382 and 383 of the pressure sensitive unit 380 can form the structural members the solenoid unit 300B, more concretely, the movable core and the fixed core so as to simplify the structure of the control valve 300, decrease the production cost of the control valve 300, and make the production of the control valve 300 easy.

In the control valve 300, the spring 384 is disposed in the internal space of the end member 383. As a result, it becomes possible to increase the outer diameters of the end members 382a and 383a projecting into the internal space of the bellows 381 up to a level substantially the same as the inner diameter of the bellows 381. Thus, sufficiently large magnetic pole area can be achieved between the two end members 382a and 383a.

In the control valve 300, the transfer rod 386 made of non-magnetic material for transferring the biasing force of the spring 384 is provided with the minimum clearance restriction member 386a for restricting the minimum clearance between the end member 382 and the end member 383 to a predetermined level. Therefore, no other minimum clearance restriction member for restricting the minimum clearance between the end member 382 and the end member 383 to a predetermined level is necessary. Thus, the structure of the control valve 300 becomes simple.

In the control valve 300, the solenoid unit 300B comprises a sleeve 370 of cylindrical form closed at one end for accommodating the pressure sensitive unit 380 in its center portion. The outer circumferential surface of the end member 383 of the pressure sensitive unit is press fitted in and fixed to the inner circumferential surface of the sleeve 370, and the outer circumferential surface of the end member 382 of the pressure sensitive unit is slidably supported by the inner circumferential surface of the sleeve 370. Therefore, the pressure sensitive unit 380 can be easily supported by and fixed to the sleeve 370. Deflection of the end member 382 in the radial direction also can be restricted by the sleeve 370.

In the control valve 300, the end member 382 is provided with at least one groove 382e on the outer circumferential surface for communicating the chamber 310c with the space 390 around the bellows 381. Therefore, internal pressure Pc of the crank chamber 105 is reliably applied to the space around the bellows 381 so as to expand and contract the bellows 381 in response to fluctuation of the internal pressure Pc of the crank chamber 105.

In the control valve 300, the internal pressure of the pressure sensitive unit 380 is kept negative. Therefore, no foreign matters entrained by the refrigerant gas enters into the space between the end members 382 and 383. Thus, the operation of the bellows 381 is not obstructed by the foreign matters.

The control valve 300 controls not only the open and close of the communication passage 125 between the outlet chamber 120 and the crank chamber 105 but also the open and close of the communication passage 129 between the crank chamber 105 and the inlet chamber 119 so as to communicate the crank chamber 105 with the inlet chamber 119 through two communication passages. Therefore, refrigerant in the crank chamber 105 can be rapidly passed into the inlet chamber 119.

Variable capacity swash-plate type compressors control the internal pressure of the crank chambers by control valves each comprising a pressure sensitive unit for detecting refrigerant pressure and a solenoid unit for determining the operating point of the pressure sensitive unit. When the control valve 300 is used for a variable capacity swash-plate type compressor, the structure of the control valve becomes simple and production cost of the control valve decreases.

In the control valve 300, the connection between the valve body 320 and the pressure sensitive unit 380 forms a valve mechanism, and the connection member 387 and the connection member 320c are made of non-magnetic material. Therefore, the contact region between the connection member 387 and the connection member 320c does not attract magnetic foreign matters. Therefore, the contacting and detaching operation of the connection member 387 and the connection member 320c is not obstructed by magnetic foreign matters.

### Preferred Embodiment 2

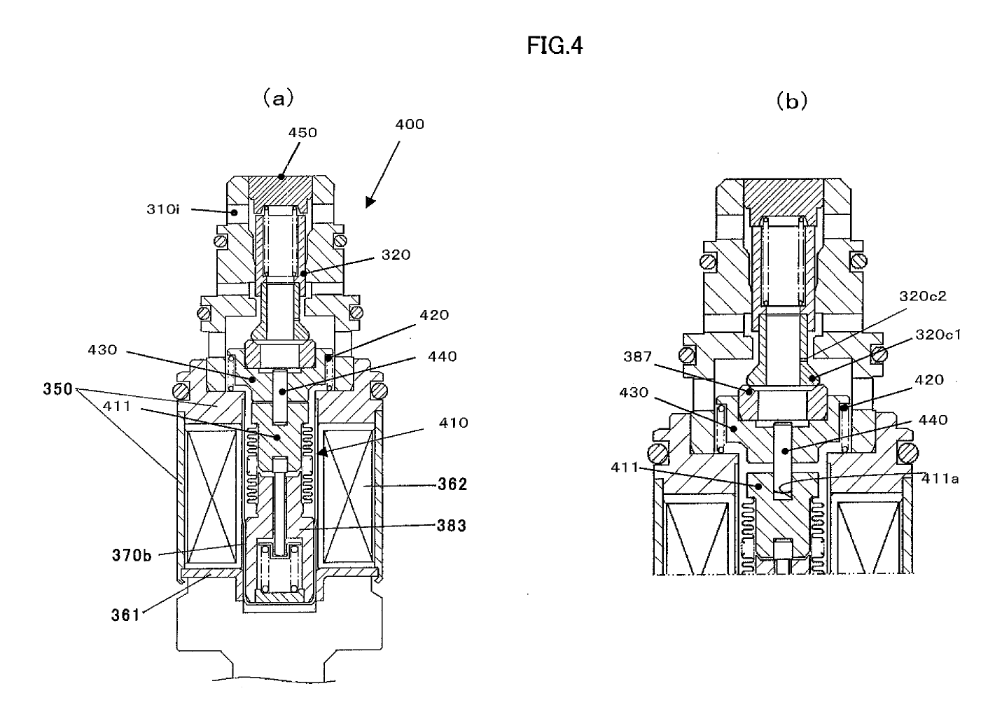

FIG. 4 shows a control valve 400 which is a variation of the control valve 300 shown in FIG. 2. In the control valve 400, the movable core of the solenoid unit is divided into a first movable core 411 forming a movable end member of a pressure sensitive unit 410 and a second movable core 430 disposed adjacent to the first movable core 411 and forced by a spring 420 in the opening direction.

When electric current is applied to the coil 362, the second movable core 430 is attracted by and united with the first movable core 411 to form a movable end member of the pressure sensitive unit, thereby performing the same operation as the control valve 300 shown in FIG. 2. In the control valve 400, the solenoid housing 350, the plate 361, the small diameter portion 370b of the sleeve 370, the end member 383, the first movable core, i.e., the end member 411, and the second movable core 430 cooperate to form a magnetic circuit. The operation characteristic of the control valve 400 is as follows. In the following formula (5), fs1 means biasing force of the spring 330 and fs2 means biasing force of the spring 420.

Ps=−(f(I)/Sr)+(Fb+fs2−fs1)/Sr (5)

When the coil 362 is demagnetized, the electromagnetic force becomes zero. Therefore, even if the bellows 381 contracts to detach the connection member 387 from the tip portion 320c1 of the connection member 320c, the second movable core 430 is detached from the first movable core 411 by the biasing force of the spring 420, and the connection member 387 contacts the tip portion 320c1 of the connection member 320c to move the valve body 320, thereby forcing the valve hole 310d to open. Thus, the aperture of the first communication passage 125 becomes maximum, and the refrigerant gas passes into the crank chamber 105 from the outlet chamber 120 to increase the internal pressure of the crank chamber 105, thereby keeping the capacity of the compressor at the minimum level. The control valve 400 can operate in the same manner as the control valve 300 and also can make the aperture of the first communication passage 125 at the maximum level when the coil 362 is demagnetized. The control valve 400 is suitable for use in a clutchless compressor.

A rod 440 made of non-magnetic material is press fitted in and fixed to the second movable core 430. The rod 440 is fitted in a guide hole 411a formed in the first movable core 411 at one end. When the second movable core 430 is attracted by the first movable core 411, the one end of the rod 440 abuts the closed end of the guide hole 411a to make a small clearance between the first movable core 411 and the second movable core 430, thereby preventing adhesion of the second movable core 430 to the first movable core 411. Therefore, the second movable core 430 can be rapidly detached from the first movable core 411 when the coil 362 is demagnetized.

The control valve 400 is not provided with a hole formed in an adjusting member 450 for communicating with the inlet chamber 119 which is provided for the control valve 300 shown in FIG. 2. Instead, the control valve 400 is provided with a communication hole 310i formed in the valve housing 310 for communicating with the inlet chamber 119. When the valve body 320 abuts the adjusting member 450 and the movement of the valve body is inhibited, the communication hole 320d is shut off from the chambers 310c and 310. In order to prevent the aforementioned situation, a communication hole 320c2 is formed in the connection member 320c to communicate the communication hole 320d with the chamber 310c. Therefore, the pressure in the internal space of the valve body 320, i.e., the communication hole 320d, becomes equal to the pressure in the external space of the valve body 320, i.e., the chamber 310c, no pressure difference between the internal pressure and the external pressure is applied to the valve body 320, and the valve body 320 can smoothly perform closing operation when the solenoid unit 300B applies electromagnetic force to the valve body.

In the aforementioned preferred embodiments, a spring for forcing one of the end members apart from the other of the end members is disposed in the other of the end members. The spring can be disposed in the bellows or around the bellows.

In the aforementioned preferred embodiments, the internal pressure of the pressure sensitive unit is kept negative. The internal pressure of the pressure sensitive unit can be kept at atmospheric pressure. A shim made of non-magnetic material can be disposed in the bellows and between the end members to adjust the minimum clearance between the end members by adjusting the thickness of the shim.

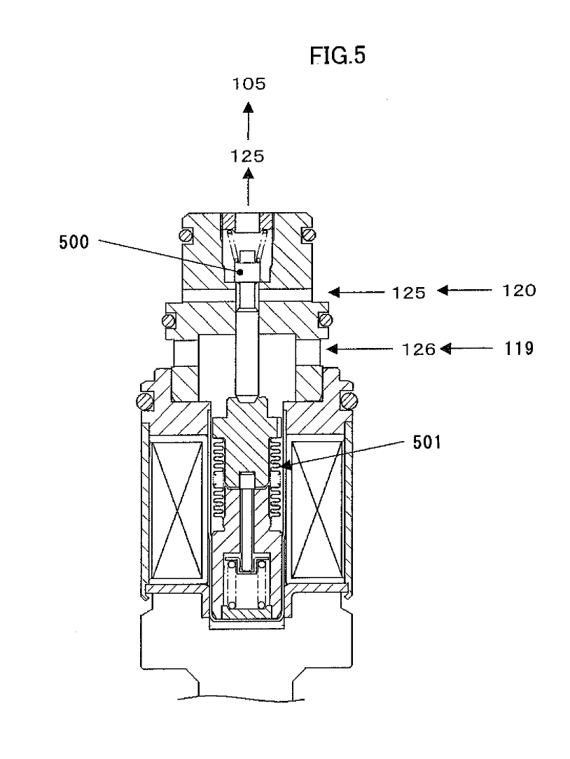

In the aforementioned preferred embodiments, a third communication passage for communicating the crank chamber with the inlet chamber is formed in the control valve. As shown in FIG. 5, the control valve can be one provided with a valve body 500 for opening and closing the first communication passage 125 but not formed with the third communication passage. As shown in FIG. 5, the internal pressure of the inlet chamber 119 can be applied to a pressure sensitive unit 501.

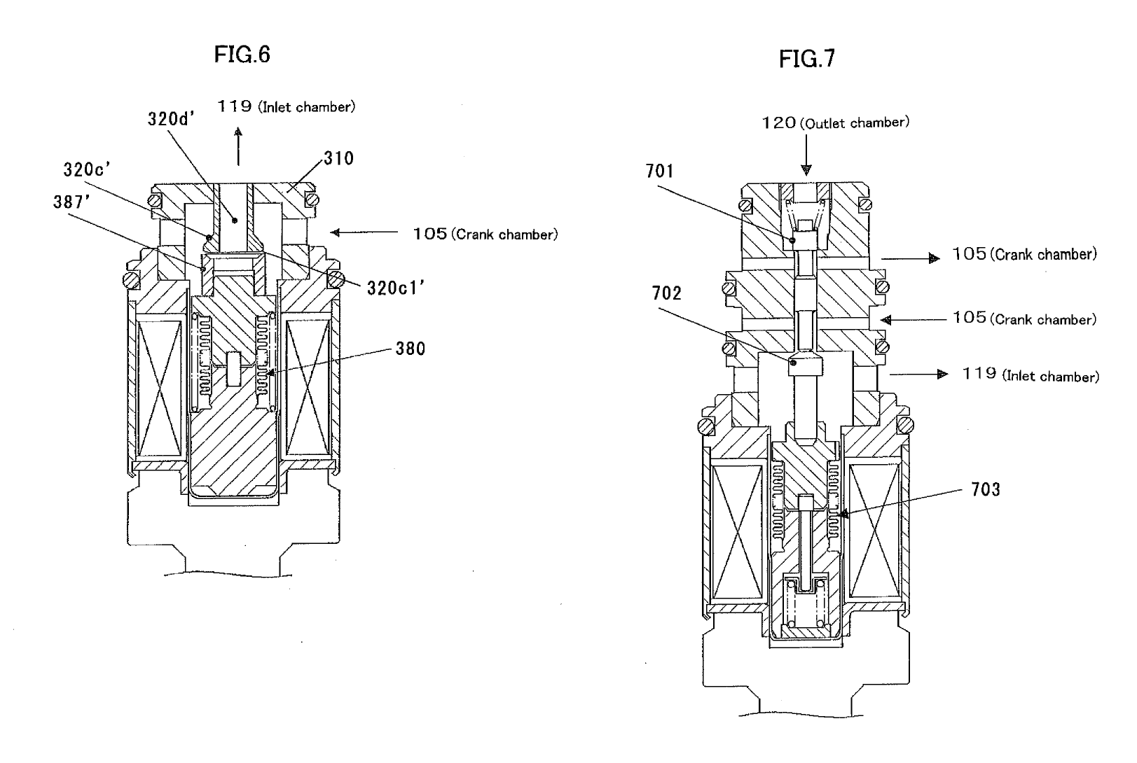

In the preferred embodiments shown in FIGS. 1 to 5, the valve body of the control valve opens and closes the communication passage between the outlet chamber and the crank chamber. As shown in FIG. 6, the valve body can open and close the communication passage between the crank chamber and the inlet chamber. In this case, the connection member 387 of the pressure sensitive unit 380 shown in FIG. 2 (d) becomes a valve body 387′, and the valve body 387′ is made of non-magnetic material. A valve seat forming member 320c′ of cylindrical form provided with a valve seat 320c1′ at one end and internally with a fluid passage 320d′ is fixed to the valve housing 310. The control valve shown in FIG. 6 has a simple structure and its production cost is low.

As shown in FIG. 7, a valve bodies 701, 702 can be disposed in the communication passages between the outlet chamber and the crank chamber, the crank chamber and the inlet chamber to be synchronously controlled by the pressure sensitive unit 703. In the control valve shown in FIG. 7, the valve body 702 moves in the opening direction when the valve body 701 moves in the closing direction. When the control valve shown in FIG. 7 is used, the opening area of the orifice hole 103c can be decreased or the orifice hole 103c can be omitted.

The area Sr for receiving the internal pressure of the inlet chamber 119, the area Sv for receiving the internal pressure of the crank chamber 105, and the effective area Sb of the bellows can be different from each other.

In the aforementioned preferred embodiment, the fluid passing through the control valve is refrigerant. The fluid passing through the control valve can be water, air, oil, or any of various other kinds of fluid.

### INDUSTRIAL APPLICABILITY

The present invention can be widely used in control valves for opening and closing fluid passages.

### BRIEF DESCRIPTION OF THE REFERENCE NUMERALS

100 Variable capacity swash-plate type compressor
101 Cylinder block
102 Front housing
103 Valve plate
104 Cylinder head
125 First communication passage
128 Second communication passage
129 Third communication passage
300 Control valve
300A Valve unit
300B Solenoid unit
380 Pressure sensitive unit
382, 383 End member

1. A control valve for opening and closing a fluid passage comprising a pressure sensitive unit provided with a bellows for receiving outside fluid pressure to expand and retract, a valve body for opening and closing a fluid passage in response to the expansion and retraction of the bellows, and a solenoid unit for applying electromagnetic force to the valve body, wherein the pressure sensitive unit is disposed in the solenoid unit, the pressure sensitive unit comprises a movable end member made of ferromagnetic material at one end of the bellows and a fixed end member made of ferromagnetic material at the other end of the bellows, the movable end member and the fixed end member oppose each other in the bellows with a predetermined distance between them, and the movable end member and the fixed end member form a part of the magnetic circuit of the solenoid unit.

2. A control valve of claim 1, wherein the solenoid unit comprises a movable core and a fixed core, and wherein the movable end member of the pressure sensitive unit forms the movable core and the fixed end member of the pressure sensitive unit forms the fixed core.

3. A control valve of claim 1, further comprising a biasing member for forcing the movable end member away from the fixed end member, wherein the biasing member is disposed in the internal space of the fixed end member.

4. A control valve of claim 3, further comprising a transfer rod made of non-magnetic material and extending through the internal space of the fixed end member to abut the movable end member, wherein the biasing member forces the movable end member away from the fixed end member through the transfer rod, and the transfer rod is provided with a minimum clearance restriction member for restricting the minimum clearance between the movable end member and the fixed end member to a predetermined level.

5. A control valve of claim 1, further comprising a sleeve of cylindrical form closed at one end and accommodating the pressure sensitive unit in its center portion, wherein the outer circumferential surface of the fixed end member is press fitted in and fixed to the inner circumferential surface of the sleeve, and the outer circumferential surface of the movable end member is slidably supported by the inner circumferential surface of the sleeve.

6. A control valve of claim 5, wherein the movable end member is provided with a communication passage between the fluid passage and the space around the bellows on the outer circumferential surface.

7. A control valve of claim 1, wherein the internal pressure of the pressure sensitive unit is kept negative.

8. A control valve of claim 1, wherein the bellows is made of stainless steel.

9. A control valve of claim 1, wherein the fluid is refrigerant flowing in a variable capacity swash-plate type compressor, the fluid passage is a communication passage between an outlet chamber and a crank chamber of the compressor and/or a communication passage between the crank chamber and an inlet chamber of the compressor, and the fluid pressure is the internal pressure of the crank chamber or the internal pressure of the inlet chamber.

10. A variable capacity swash-plate type compressor comprising the control valve of claim 9.

11. A variable capacity swash-plate type compressor of claim 10, comprising a housing accommodating an outlet chamber, an inlet chamber, a crank chamber and a plurality of cylinder bores, a plurality of pistons each fitting in one of the cylinder bores, a driving shaft extending across the crank chamber, a conversion device provided with a swash plate variable in inclination to convert rotation of the driving shaft to reciprocation of the pistons, a first communication passage for communicating the outlet chamber to the crank chamber, the control valve for opening and closing the first communication passage, a second communication passage for communicating the crank chamber to the inlet chamber, and an aperture disposed in the second communication passage, wherein the aperture of the control valve is controlled to control the internal pressure of the crank chamber, thereby controlling the stroke of the pistons to control flow rate of the refrigerant sucked into the cylinder bores from the inlet chamber, and wherein the control valve forms an autonomous control valve mechanism for autonomously controlling the internal pressure of the inlet chamber at a predetermined level when the pressure sensitive unit is connected to the valve body, wherein the valve body moves in the direction for closing the first communication passage when the internal pressure of the inlet chamber becomes higher than said level determined by the electromagnetic force of the solenoid, and the valve body moves in the direction for opening the first communication passage when the internal pressure of the inlet chamber becomes lower than said level, and wherein the connection between the pressure sensitive unit and the valve body forms a valve mechanism for forming a third communication passage extending through the valve body so as to communicate the crank chamber with the inlet chamber when the pressure sensitive unit and the valve body are disconnected from each other, and wherein the movable end member of the pressure sensitive unit is provided with a connection member for connecting to the valve body, the connection member is fixed to the movable end member, and the connection between the pressure sensitive unit and the valve body is made of non-magnetic material.
